(19) United States
(12) Patent Application Publication
(10) Pub. No.: US 2015/0219534 A1
(43) Pub. Date: Aug. 6, 2015

(54) Biological Sample Preparation Devices And Methods

(71) Applicant: APPLIED BIOSYSTEMS, LLC, Carlsbad, CA (US)

(72) Inventors: Nigel P. Beard, San Diego, CA (US); James C. Nurse, Westport, WA (US)

(21) Appl. No.: 14/613,581

(22) Filed: Feb. 4, 2015

Related U.S. Application Data
(63) Continuation of application No. 12/165,507, filed on Jun. 30, 2008, now abandoned.
(60) Provisional application No. 60/947,303, filed on Jun. 29, 2007.

(51) Int. Cl. G01N 1/28; B01L 3/00

(52) U.S. Cl. CPC G01N 1/286; B01L 3/502715; B01L 3/502753; B01L 2300/0877; B01L 2300/087; B01L 2300/0832; B01L 2400/0481; B01L 2300/06

(57) ABSTRACT

A device according to various embodiments can include a first chamber and a second chamber configured to contain at least one biological sample. A triturating element is interdisposed between the first chamber and the second chamber and provides fluid communication between the first chamber and the second chamber.

### CROSS-REFERENCE TO RELATED APPLICATION

This application is a continuation of U.S. application Ser. No. 12/165,507 filed Jun. 30, 2008, which claims a priority benefit under 35 U.S.C. §119(e) from U.S. Application No. 60/947,303 filed Jun. 29, 2007, all of which are incorporated herein by reference.

### DESCRIPTION

1. Field

The present teachings relate to devices and methods for preparing biological samples, such as, for example, nucleic acid samples, for biological sample assays, such as, for example, polymerase chain reactions (PCR).

2. Introduction

In the biological research, clinical diagnostic, and security screening fields, biological assays including polymerase chain reactions and/or other reactions, such as, for example, ligase chain reactions, antibody binding reactions, oligonucleotide ligations assay, and hybridization assays, are used to ascertain desired information about a biological sample. Typically, for more accurate results, the biological sample is prepared according to a pre-determined protocol to make the nucleic acids of interest available for amplification or other type of assay. Methods of amplification are known to those skilled in the art, and are described in part in U.S. Patent Application Publication No. 2005/0233363 A1, which published Oct. 20, 2005 and is entitled “WHOLE GENOME EXPRESSION ANALYSIS SYSTEM.” Often, highly trained personnel must perform such sample preparations and one or more subsequent assays. In some cases, samples collected in the field or at a clinic must be sent away to remote laboratories that have the trained personnel and equipment for such sample preparation and assays.

Providing a sample preparation protocol that could be used by personnel in the field or clinic, who may have less training than those in research or testing laboratories, may facilitate the performance of biological assays. For example, it may be desirable to provide a disposable device configured to carry out sample preparation. It also may be desirable to provide a disposable device that integrates sample preparation and biological assay protocols, such as those described in U.S. Provisional Application No. 60/870589, the contents of which are explicitly incorporated by reference herein.

Numerous biological molecules exist inside the cell and can be released from the cell by cell disruption (lysis). Cell disruption is a sensitive process because of the cell wall's resistance to the high osmotic pressure inside them. Structures for disrupting the cells for the purpose of extracting nucleic acid are well known. Cell disruption can be accomplished by various mechanical, chemical, biological, or physical means.

Chemical methods may employ lysing agents, such as, for example, detergents, enzymes or strong organics to disrupt the cells and release the nucleic acids, followed by treatment of the extract with chaotropic salts to denature any contaminating or potentially interfering proteins. In some cases, the use of harsh chemicals for disrupting cells can inhibit subsequent amplification of the nucleic acid. In using chemical disruption methods, therefore, it is typically necessary to purify the nucleic acid released from the cells before proceeding with further analysis. Such purifications steps can be relatively time-consuming and expensive, and can reduce the amount of nucleic acid recovered for analysis.

In some mechanical methods, intracellular products are released from microorganisms mainly by mechanical disruption of the cells. In other words, the cell envelope is physically broken, releasing all intracellular components into the surrounding medium. These methods generally rely on fluid shear and/or compression to rupture the cell wall and membrane. Mechanical equipment that has been employed for cell disruption includes, for example, homogenizers, ball mills, ultrasonic disruption and blenders. In general, such equipment is relatively large. Prepared sample from these types of equipment may need to be transferred from the equipment to different locations and devices for assaying, which may require an individual performing the sample preparation and/or assaying to transfer the sample from one device to another. In transferring the prepared sample, contaminates can be introduced, and personnel can be exposed to pathogens therein.

It may be desirable to provide a cell disruption technique for preparing a biological sample that does not use chemical substances that may negatively affect a subsequent biological assay, such as, for example, PCR. It also may be desirable to provide a cell disruption technique that may be integrated with a biological assay device, so as to avoid the use of external equipment. It also may be desirable to provide a cell disruption technique that is relatively efficient and simple in terms of design and implementation. For example, it may be desirable to provide a technique that requires relatively fewer fluid manipulation steps than conventional techniques.

### SUMMARY

The present invention may satisfy one or more of the above-mentioned desirable features. Other features and/or advantages may become apparent from the description which follows.

A device according to various exemplary embodiments can include a first chamber and a second chamber configured to contain at least one biological sample. A triturating element may be interdisposed between the first chamber and the second chamber and provide fluid communication between the first chamber and the second chamber.

A method of performing a biological analysis according to various exemplary embodiments can include supplying at least one of a plurality of chambers with at least one biological sample; flowing the at least one biological sample between a first chamber of the plurality of chambers and a second chamber of the plurality of chambers by way of a triturating element; and disrupting at least one cell of the at least one biological sample by flowing the at least one biological sample through the triturating element at least once.

A sample preparation device according to various exemplary embodiments can include at least a first fluidic bag and a second fluidic bag for holding a liquid and having a flexible and collapsible configuration. A triturating element may be disposed so as to fluidly interconnect the first and second fluidic bags to flow liquid through the triturating element and to exert a shear force on the liquid.

In the following description, certain aspects and embodiments will become evident. It should be understood that the invention, in its broadest sense, could be practiced without having one or more features of these aspects and embodiments. It should be understood that these aspects and embodiments are merely exemplary and explanatory and are not restrictive of the invention.

### BRIEF DESCRIPTION OF THE DRAWINGS

The skilled artisan will understand that the drawings described below are for illustrative purposes only. The drawings are not intended to limit the scope of the present teachings in any way.

FIG. 1 is a perspective view of an exemplary embodiment of a sample preparation device in accordance with the present teachings;

FIG. 2A is a cross-sectional view of the device of FIG. 1 taken along line 2-2 of FIG. 1 and depicts an exemplary embodiment prior to the introduction of a sample or other fluid;

FIG. 2B is a cross-sectional view of the device of FIG. 1 taken along line 2-2 of FIG. 1 and depicts an exemplary embodiment of a sample being introduced through a sample inlet port;

FIG. 2C is a cross-sectional view of the device of FIG. 1 taken along line 2-2 of FIG. 1 and depicts an exemplary embodiment for using the device for sample preparation;

FIG. 2D is a cross-sectional view of the device of FIG. 1 taken along line 2-2 of FIG. 1 and depicts an exemplary embodiment for using the device for sample preparation;

FIG. 2E is a cross-sectional view of the device of FIG. 1 taken along line 2-2 of FIG. 1 and depicts an exemplary embodiment for using the device to transfer prepared sample from the device;

FIG. 3 is another exemplary embodiment of a sample preparation device according to the present teachings;

FIG. 4A is a perspective view of an exemplary embodiment of a triturating element according to the present teachings;

FIG. 4B is a perspective view of an exemplary embodiment of through-hole of the triturating element of FIG. 4A;

FIG. 4C is a perspective view of yet another exemplary embodiment of through-hole of the triturating element of FIG. 4A;

FIG. 4D is a perspective view of another exemplary embodiment of a through-hole of the triturating element of FIG. 4A;

FIG. 5A illustrates the internal structure of the exemplary embodiment of FIG. 4A;

FIG. 5B illustrates the internal structure of the exemplary embodiment of FIG. 4B;

FIG. 5C illustrates the internal structure of the exemplary embodiment of FIG. 5C;

FIG. 5D illustrates the internal structure of the exemplary embodiment of FIG. 5D;

FIG. 6 is a plan view of an exemplary embodiment of a device that integrates sample preparation with sample assay according to the present teachings; and

FIG. 7 is a graph showing lysing power as a function of the number of actuations for repeatedly flowing sample through the triturating element.

FIG. 7 is a graph showing lysing power as a function of the number of actuations for repeatedly flowing sample through the triturating element.

FIG. 8 is a plan view of a pattern of structures within a triturating element, formable by photolithography.

FIG. 9 is a plan view of another pattern of structures within a triturating element, formable by photolithography.

FIG. 10 is a plan view of a yet another pattern of structures within a triturating element, formable by photolithography.

FIGS. 11A and 11B are side and top views of a substrate for use in forming an embodiment of device 100 partially through photo-lithography.

FIG. 12A and 12B are side and top views of a substrate of FIGS. 11A and 11B and an applied photo-imagable layer.

FIG. 13A and 13B are side and top views of a substrate of FIGS. 11A-12B with a photo-imaged layer with desired features formed therein.

FIG. 14A and 14B are side and top views of an embodiment of device 100 assembled by attaching a pre-formed plastic layer to the photo-imaged layer of FIGS. 13A and 13B.

### DETAILED DESCRIPTION OF VARIOUS EMBODIMENTS

Reference will now be made to various embodiments, examples of which are illustrated in the accompanying drawings. However, these various exemplary embodiments are not intended to limit the disclosure. On the contrary, the disclosure is intended to cover alternatives, modifications, and equivalents.

Throughout the application, description of various embodiments may use “comprising” language, however, it will be understood by one of skill in the art, that in some specific instances, an embodiment can alternatively be described using the language “consisting essentially of” or “consisting of.”

For purposes of better understanding the present teachings and in no way limiting the scope of the teachings, it will be clear to one of skill in the art that the use of the singular includes the plural unless specifically stated otherwise. Therefore, the terms “a,” “an” and “at least one” are used interchangeably in this application.

Unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained. In some instances, “about” can be understood to mean a given value ±5%. Therefore, for example, about 100 nl, could mean 95-105 nl. At the very least, each numerical parameter should at least be construed in light of the number of reported significant digits and by applying ordinary rounding techniques.

The term “nucleic acid” can be used interchangeably with “polynucleotide” or “oligonucleotide” and can include single-stranded or double-stranded polymers of nucleotide monomers, including 2′-deoxyribonucleotides (DNA) and ribonucleotides (RNA) linked by internucleotide phosphodiester bond linkages, or internucleotide analogs, and associated counter ions, for example, H+, NH4+, trialkylammonium, Mg2+, Na+ and the like. A polynucleotide may be composed entirely of deoxyribonucleotides, entirely of ribonucleotides, or chimeric mixtures thereof. Polynucleotides may be comprised of nucleobase and sugar analogs. Polynucleotides typically range in size from a few monomeric units, for example, 5-40 when they are frequently referred to in the art as oligonucleotides, to several thousands of monomeric nucleotide units. Unless denoted otherwise, whenever a polynucleotide sequence is represented, it will be understood that the nucleosides are in 5′ to 3′ order from left to right and that “A” denotes deoxyadenosine, “C” denotes deoxycytidine, “G” denotes deoxyguanosine, and “T” denotes thymidine, unless otherwise noted. A labeled polynucleotide can comprise modification at the 5′terminus, 3′terminus, a nucleobase, an internucleotide linkage, a sugar, amino, sulfide, hydroxyl, or carboxyl. See, for example, U.S. Pat. No. 6,316,610 B2, which issued Nov. 13, 2001 and is entitled “LABELLED OLIGONUCLEOTIDES SYNTHESIZED ON SOLID SUPPORTS,” which is incorporated herein by reference. Similarly, other modifications can be made at the indicated sites as deemed appropriate.

The term “reagent” should be understood to mean any reaction component that in any way affects how a desired reaction can proceed or be analyzed. The reagent can comprise a reactive or non-reactive component. It is not necessary for the reagent to participate in the reaction. The reagent can be a recoverable component comprising, for example, a solvent and/or a catalyst. The reagent can comprise a promoter, accelerant, and/or retardant that is not necessary for a reaction but affects the reaction, for example, affects the rate of the reaction. A reagent can comprise, for example, one member of a binding pair, a buffer, and/or a DNA that hybridizes to another DNA. The term “reagent” is used synonymous with the term “reaction component.”

Various embodiments of the sample preparation devices described herein enable sample preparation without the addition of chemistries that require a chemical neutralization step to avoid negatively affecting the subsequent PCR reaction, making such embodiments suitable for regulated or field-deployable applications. Various embodiments of the sample preparation devices described herein enhance chemical sample preparation methods to extend the range of nucleic acid sources that can be relatively quickly disrupted. In various embodiments, the operation of the device may be relatively simple and robust, and may enable sample preparation without external mechanical devices or equipment to perform cell disruption. This may permit usage by minimally trained personnel. In various embodiments, a sample preparation device may be in the form of a consumable product, configured to be disposed after use, or may be in the form of a reusable product.

Various embodiments combine a triturating element and an integrated sample preparation bag design. Usage of the terms “triturating element” and/or “fluid shearer” can be used herein to refer to a mechanism that can create a shearing force on a liquid and/or another substance that flows through the triturating element and/or fluid shearer. Depending on the number of times the substance flows through a triturating element (fluid shearer), the shearing force may be sufficient so as to disrupt one or more cell membranes of cells within the substance to extract desired contents, e.g., nucleic acid, from one or more cells.

In various embodiments, disruption of a wide variety of different kinds of cells may be accomplished using substantially the same device since virtually unlimited numbers of shapes of the one or more passages in the fluid shearer can be designed and used to meet the specific needs of a particular sample preparation protocol. For example, various embodiments of the device can be used across a wide range of sources of nucleic acid, including, but not limited to, for example, mammalian epithelial cells (buccal cells), gram-negative and gram-positive bacteria, and/or bacterial spores such as B. anthracis.

Various embodiments enable a user to apply pressure manually to facilitate disruption. Various embodiments enable a user to automatically apply pressure via controlled instrumentation to facilitate disruption.

In various embodiments, a user can control the disruption efficiency by selecting the configuration (e.g. size and shape) of the at least one through-hole defined within the triturating element based upon at least one cell of the biological sample that is selected for disruption. Various embodiments also enable a user to obtain greater efficiency and higher disrupting power by increasing the number of actuations performed while preparing the sample by flowing the sample through the triturating element (e.g., repeatedly flowing the sample through the triturating element). In various embodiments, an actuation includes flowing the sample through the triturating element from one fluidic bag to another.

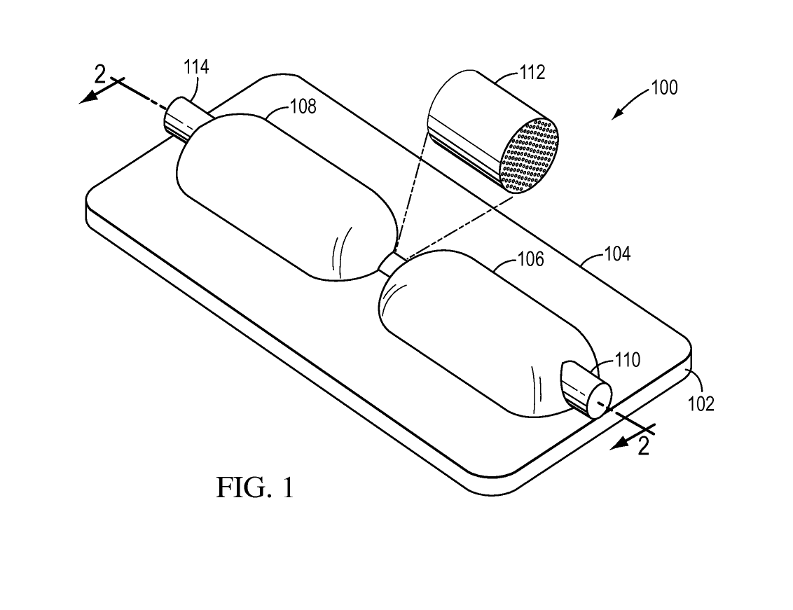

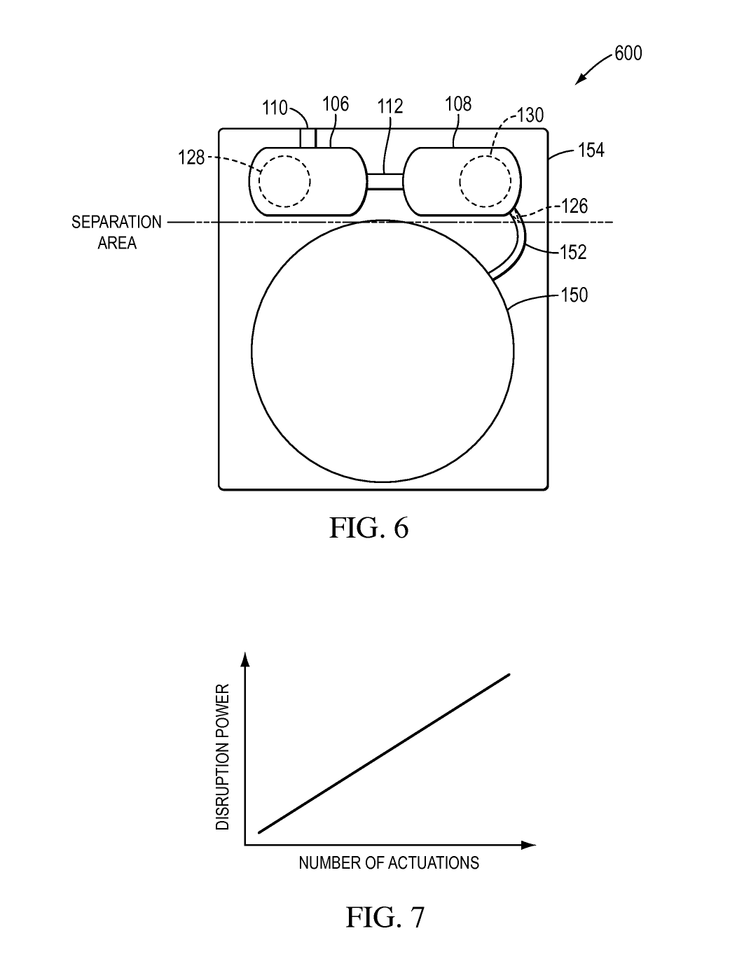

An exemplary embodiment of a biological sample preparation device 100 that can be used, for example, to disrupt a cell and release its contents, which may include, for example, a nucleic acid sample, is illustrated in FIG. 1. The device 100 can provide a sample preparation zone 154 (for example, as shown in the exemplary embodiment of FIG. 6) for performing a preparation protocol on a biological sample prior to loading the processed sample into a reaction zone 150 (shown in the exemplary embodiment of FIG. 6) at which a desired biological assay may occur.

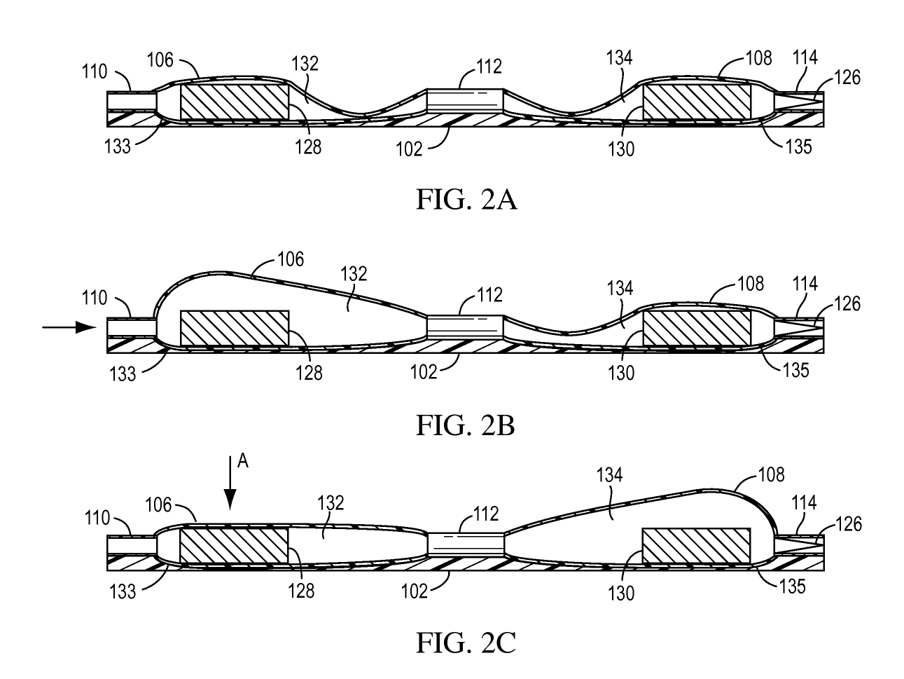

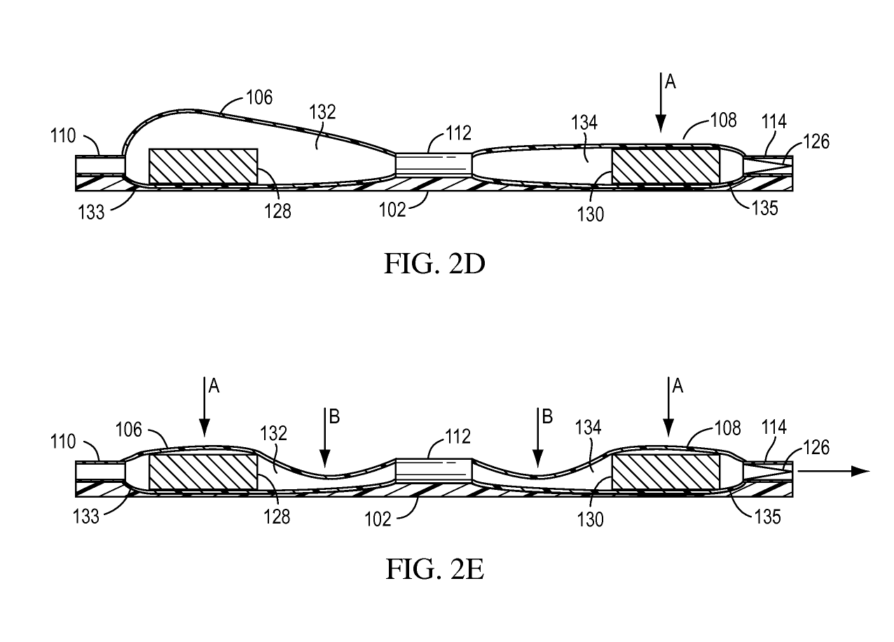

The sample preparation device 100 can include a substantially rigid base plate 102 that provides a supporting structure. The rigid base plate 102 may have at least one recess (133 in FIGS. 2A and 2B) formed in its top surface. A top layer 104 that may be made of a material that forms a water and vapor barrier may be adjacent and bonded to the base plate 102 at least near edges of the recess. Top layer 104 may include at least one formed portion 106 that is raised above the generally planar surface of the top layer 104.

The formed portion 106 together with the recess in the base plate 102 may define a chamber 132 (shown in FIGS. 2A-2E) configured to receive the biological sample for pre-processing sample prior to loading the processed sample into, for example, a reaction zone (e.g., reaction zone 150 shown in FIG. 6). In an alternative arrangement, the base plate 102 may have a substantially planar surface free of recesses, and the formed portion 106 together with the top planar surface of the top layer may define the chamber. Access to the chamber 132, shown in FIGS. 2A-2E, defined between the fluidic bag 106 and the base plate 102 can be selectively gained through a sample inlet port 110, which can be a separate piece mounted to the base plate 102 or may be integral with the base plate 102. An example of a separate sample inlet port 110 is a luer-lock valve, such as, for example, part #V2470, available for Halkey-Roberts. Those having skill in the art would understand, however, that other mechanisms for providing selective access to the chamber 132 may be employed.

Formed portion 106 of the top layer 104 is sometimes referred to herein as a fluidic bag 106. Multiple fluidic bags may be employed in various embodiments. Using multiple fluidic bags connected in parallel, series, or both can enable multiple sample preparation reagents, the addition of reagents, splitting the contents of a fluidic bag into two or more reaction volumes, multiple step sample preparation, and filtration and/or multiple filtrations of a sample.

The exemplary embodiment of FIG. 1 illustrates a sample preparation device 100 that includes two fluidic bags 106 and 108. Fluidic bag 108 may have a similar configuration as fluidic bag 108 and define a formed portion that is raised above the substantially planar surface of the other portions of top layer 104, as shown in FIG. 1. A recess 135, shown in FIGS. 2A-2E, may be provided in the base plate 102, and the fluidic bag 108 together with the recess 135 may define a chamber 134. Alternatively, the base plate 102 top surface may be substantially planar without a recess and the fluidic bag 108 and top surface of the base plate 102 may define the chamber.

A triturating element 112 may be positioned, and provide a fluid communication, between the fluidic bags 106 and 108. A sample outlet port 114 may be provided in fluid communication with the chamber 134 for transferring the processed sample out of the sample preparation device 100. Sample outlet port 114 can be a separate piece mounted to the base plate 102 or may be integral with the base plate 102.

In various exemplary embodiments, such as, for example, in the exemplary embodiments of FIGS. 1-3, base plate 102, which in some embodiments can be thermally-conductive material such as, for example, aluminum foil or thin polymeric film, can be coated with an adhesive in a pattern via a printing method such as, for example, pen printing, silk screening, inkjet printing, among others, to form an adhesive layer (not shown). The adhesive layer can also be, for example, double-sided adhesive tape with the pattern cut via die or laser among other methods. Adhesive layer can be, for example, a heat-seal film, which when heated to a known temperature melts and seals to top layer 104 to base plate 102. Top layer 104 can also be bonded directly to base plate 102 via thermal bonding, heat lamination, ultrasonic welding, IR welding, laser welding and RF welding to name examples of bonding methods.

In some embodiments, an adhesive layer (not shown) can be approximately 25 μm and 125 μm. In some embodiments, the adhesive layer can be from 25 μm to about 75 μm thick. In some embodiments, top layer 104 will be at least approximately 1 mm thick. In some embodiments, base plate 102 will be at least 1 mm thick. In some embodiments, top layer 104 can be between 1 to 100 times as thick as the adhesive layer. In some embodiments, base plate 102 can be between 1 and 200 times as thick as the adhesive layer.

Referring to FIGS. 2A-2E, fluidic bags 106 and 108 may be deformed to take a variety of shapes during the different stages of the sample preparation process. Fluidic bags 106 and 108 may take any desired shape. A general discussion of various exemplary shapes that the fluidic bags 106 and 108 may take during the different stages of the process will be provided with reference to FIGS. 2A-2E. Then, the device 100 will be described in more detail with reference to the exemplary embodiments of FIGS. 2A-2E. The fluidic bags 106 and 108 depicted in the exemplary embodiment of FIG. 1 are shown with the chambers 132 and 134 of FIGS. 2A-2E filled with a sample. When chambers 132 and 134 are not filled with the sample, however, the fluidic bags 106 and 108 may have a deflated, puckered form. For simplicity the fluidic bags illustrated in FIGS. 2A through 2E are shown with smooth surface profiles in all states operation. One skilled in the art would recognize that in a less than full state, a fluidic bag can have a puckered appearance, for example, as non-elastically deformable material folds to accommodate the reduced fluid volume.

An assembled device, such as that illustrated in FIG. 2A or described elsewhere in the application can be labeled and packaged for shipping to a customer, who will introduce a biological sample. FIG. 2A illustrates the device 100 prior to the introduction of the sample. In some embodiments prior to the sample introduction, both fluidic bags 106 and 108 may be volumeless (e.g., not filled with sample), but not completely flat. The exemplary embodiment of FIG. 2A illustrates this volumeless state such that both fluidic bags 106 and 108 are collapsed downward into chambers 132 and 134 to conform around recesses 133 and 135 and pressure restrictors 128 and 130, if any. In some exemplary embodiments, the material of the fluidic bags may not be elastic or may have relatively negligible stretching properties. Thus, when the fluidic bags 106 and 108 are volumeless and fold upon themselves, they may have a deflated, puckered form, rather than a smooth surface profile. FIG. 2A illustrates a deflated appearance of fluidic bags 106 and 108 prior to introduction of the sample.

Depending on the mechanical properties of the fluidic bags 106 and 108, in some embodiments, fluidic bags 106 and 108 may be collapsible so as to collapse into chambers 106 and 108 to contact base plate 102 and cover pressure restrictors 128 and 130. In some embodiments, fluidic bags 106 and 108 may not collapse to contact the base plate 102, but may collapse at least partially into chambers 132 and 134, thereby reducing the volume of chambers 132 and 134.

In some embodiments as illustrated in FIG. 2B, a fluid, which may contain a biological sample or analyte, can be introduced to device 100 through sample inlet port 110, as will be explained in more detail below. The fluid may be introduced under pressure to device 100 expanding fluidic bag 106, which prior to introduction of the fluid had zero-volume or negligible volume compared to the volume of fluid introduced to the device. The top layer of fluidic bag 106 is moved away from base plate 102 by the advancing fluid, for example, as it is inflated, as illustrated in FIG. 2B. As fluidic bag 106 expands during the introduction of the fluid, fluidic bag 108 remains collapsed. FIG. 2B illustrates the state of the device 100 after introduction of biological sample to the fluidic bag, thus filling chamber 132.

FIGS. 2C and 2D illustrate fluidic bags 106 and 108 and the triturating element 112 during sample preparation. As illustrated in FIGS. 2C and 2D, fluidic bags 106 and 108 may be deformable (e.g., compressible) and depressed toward base plate 102 to exert pressure on any fluid in the chambers 132 and 134, respectively, defined between fluid bags 106 and 108 and base plate 102. FIGS. 2C and 2D illustrate the actuation that performs the sample preparation during transfer of the fluid back and forth from chamber 132 to chamber 134 by alternating compression of fluidic bags 106 and 108. This alternating compression of the fluidic bags 106 and 108 is depicted by the downwardly facing arrows A in FIGS. 2C and 2D. Applying a force as depicted by arrow A in FIG. 2C to compress fluidic bag 106 increases the pressure of any fluid in the chamber 132, causing at least some of the pressurized fluid to move through the triturating element 112 into the chamber 134. In some embodiments, the pressure on 106 is then released. Then, in a similar manner, a force can be applied to compress the fluidic bag 108, thereby exerting pressure on any fluid present therein and returning at least some of the fluid back through the triturating element 112 and back into the chamber 132. The repeated back and forth transmission of at least some of the fluid between the fluidic chambers 132 and 134 through the triturating element 112 may generate sufficient shear stress on the fluid (e.g., biological sample), as will be explained in more detail below, to prepare the biological sample, for example, by disrupting one or more cells in the biological sample. In various exemplary embodiments, the number of actuations of repeated transmission of the sample through triturating element 112 to achieve the desired sample preparation can depend upon at least one specific cell of the biological sample that is selected for disruption.

FIG. 2E depicts an exemplary embodiment for using the sample preparation device 100 to transfer the prepared sample from the device 100. In one embodiment, the device 100 can be configured to transfer the prepared biological sample from the device 100 through outlet port 114 by causing the fluid pressure to overcome the threshold pressure of a valve 126 in outlet port 114. Thus, depressing fluidic bags 106 and 108, for example, at a location in addition to above pressure restrictors 128 and 130, for example, at the location indicated by the downwardly facing arrows B in FIG. 2E, may pressurize the fluid in chambers 132 and 134 above the threshold pressure of one-way flow valve 126, thereby opening valve 126. Fluid will then flow through outlet port 114 and exit from the device 100, deflating fluid bags 106 and 108 so that they have a deflated (e.g., puckered) form.

When using the device 100 for biological sample preparation, a biological sample can be introduced into the chamber 132 via sample inlet port 110. Sample inlet port 110 shown in FIGS. 2A-2E, may be used to prevent sample in fluidic bag 106 from flowing back out of the inlet port 110 once introduced into the chamber 132. Those having skill in the art would recognize various flow control mechanisms and/or configurations of inlet port 110 that may be used to prevent the sample introduced into the chamber 132 from flowing back out of the inlet port 110.

A biological sample containing cells or other intact nucleic acid source may be introduced into the chamber 132 via sample inlet port 110. In various exemplary embodiments, a swab containing cellular or other biological sample can be inserted through sample inlet port 110 and moved within the chamber 132, which may be pre-filled with liquid containing lysis and other sample preparation reagents. In various embodiments, chamber 132 may be pre-filled with beads to assist with collecting undesired components of the to-be-disrupted sample. The sample may be released from the swab as a result of contact with the liquid in the chamber 132 before removing the swab through sample inlet port 110. A luer-lock valve may function as sample inlet port 110 and provide selective access to the chamber 132. In lieu of or in addition to having a luer-lock valve, sample inlet port 110 may include a room temperature vulcanized (RTV) silicone plug or other self-sealing material, which may be pierced by a needle or equivalent sharp object in order to provide access to the chamber 132.

Mechanisms other than a swab may be used to introduce sample into the chamber 132. For example, inlet port 110 may be configured to engage with a syringe to introduce sample into the chamber 132. Those skilled in the art would recognize a variety of techniques and devices that may be used to introduce sample via inlet port 110 into the chamber 132.

Alternatives to having a lysis reagent or other sample preparation reagent present in the sample preparation area as liquid may include providing those substances dried-down or lyophilized within the chamber to be solubilized by the addition of water or other liquid, whether concurrent with the addition of the biological sample or otherwise. Moreover, such reagents may also be introduced either before, after, or concurrently with the biological sample via inlet port 110. Those having skill in the art would recognize various mechanisms for supplying the chambers 132 and 134 with reagent.

Selection of materials that will come into contact with a biological sample and potential assay reagents can affect the quality of the data collected from the assay. In the case of PCR, particularly real-time PCR, several materials have been identified as sufficiently minimally affecting the data: polypropylene, polyethylene, polyurethane, and blends thereof. All of these materials can be used, as the above list is not an exclusive one.

Various flow control mechanisms, including but not limited to, for example, ports, piping, conduits, valves and/or other flow control devices (not shown in FIGS. 2A-2E) may control the flow of the fluid, reagents, and/or other substances into and out of chambers 132 and 134 of fluidic bags 106 and 108. In one embodiment, inlet port can include an insertion septum (not shown) for the introduction of a sample insertion device, such as, for example, a syringe and needle containing at least one sample selected for disrupting. The insertion septum can be constructed of a resealing elastomer such as silicone that allows a needle to puncture the septum, yet reseal after the needle is withdrawn.

In various embodiments, the flow control mechanisms may include a combination of valves and restrictors for controlling the flow of the fluid, reagent and/or other substances. With reference to FIGS. 2A-2E, valves can be provided in inlet port 110 and outlet port 114, respectively, as one-way valves that will not pass fluid in a permitted direction until a specified pressure threshold is reached. Such pressure-threshold one-way valves can be, for example, a duck-bill valve, for example, such as for valve 126 provided in sample outlet port 114, as depicted in FIGS. 2A-2E. One-way valve 126 can be designed to permit flow only above certain threshold pressures. As long as the pressure remains lower than the threshold pressures, valve 126 may function to inlet prevent the fluid from flowing out of the device during sample preparation.

In various exemplary embodiments, chambers 132 and 134 may include at least one pressure restrictor, (illustrated for simplicity as blocks 128 and 130 in FIGS. 2A-2E). The pressure restrictors 128 and 130 may be configured to control the pressure of the fluid when depressing fluid bags 106 and 108 to flow the fluid through triturating element 112 during sample preparation. By depressing fluidic bags 106 and 108, for example, at the location indicated by the downwardly facing arrows A in FIGS. 2C and 2D, pressure restrictors 128 and 130 may restrict the downward movement of fluidic bags 106 and 108 so that the fluidic bags 106 and 108 can be depressed downward until they encounter pressure restrictors 128 and 130. Thus, pressure restrictors 128 and 130 maintain the pressure of the fluid within the threshold pressure of valve 126 and any valve associated with inlet port 110, which keeps the valves closed and prevents the fluid from flowing out of inlet port 110 and outlet port 114 as pressure is applied to fluidic bags 106 and 108.

By way of example only, pressure restrictors 128 and 130, in some embodiments, may be hard stops and, therefore, do not need to be internal to the fluidic bags 106 and 108. In some embodiments, pressure restrictors 128 and 130 may be external to the fluidic bags 106 and 108, as long as when fluidic bags 106 and 108 are depressed their downward motion is limited so that the fluidic bags contact the pressure restrictors to only partially compress the fluidic bags. In some embodiments, a physical structure such as the pressure restrictors may not be needed to restrict the pressure within the fluidic bags if the distance compressed is controlled through a control system, for example.

As described above, FIG. 2C and 2D are cross-sectional views depicting the mechanism that performs the sample preparation during transfer of the fluid back and forth from chamber 132 to chamber 134 by alternating compression of fluidic bags 106 and 108. The alternating compression of the fluidic bags 106 and 108 is depicted by the downwardly facing arrows A in FIG. 2C and 2D. Compressing fluidic bag 106 increases the pressure of any fluid in the chamber 132, causing the pressurized fluid to move through the triturating element 112 into the chamber. In some embodiments, the pressure on 106 is then released. Then, in a similar manner, a force can be applied to compress the fluidic bag 108, thereby exerting pressure on any fluid present therein and returning the fluid back through the triturating element 112 and back into the chamber 132. The repeated back and forth transmission of the fluid between the fluidic chambers 132 and 134 through the triturating element 112 may generate sufficient shear stress on the fluid (e.g., biological sample), as will be explained in more detail below, to disrupt the cells and prepare the biological sample, for example, by disrupting the biological sample. In various exemplary embodiments, the number of actuations of repeated transmission of the sample through triturating element 112 to achieve the desired sample preparation can depend upon at least one specific cell of the biological sample that is selected for disruption.

FIG. 2E depicts an exemplary embodiment for using the sample preparation device 100 to transfer the prepared sample from the device 100. In one embodiment, the device 100 can be configured to transfer the prepared biological sample from the device 100 through outlet port 114 by causing the fluid pressure to overcome the threshold pressure of valve 126. Thus, in various embodiments, depressing fluidic bags 106 and 108, at any location in addition to a location above pressure restrictors 128 and 130, for example, at the location indicated by the downwardly facing arrows B in FIG. 2E, may pressurize the fluid in chambers 132 and 134 above the threshold pressure of one-way flow valve 126, thereby opening valve 126. Fluid will then flow into output port 114 and exit from the device 100.

In some exemplary embodiments, to overcome the threshold pressure of valve 126, fluidic bags 106 and 108 can be simultaneously depressed at both locations indicated by the downwardly facing arrows B in FIG. 2E. Fluidic bags 106 and 108 can be configured to be symmetrical having substantially the same shape and size, as illustrated in FIG. 1, before deflation.

In various embodiments, fluidic bag 106 can be pressurized before pressuring fluidic bag 108. In this situation, pressure will build on the biological sample in fluidic bags 106 and 108. This increased pressure may be sufficient to open valve 126, depending on the design of the device. Depression of fluidic bags 106 and 108 need not be simultaneous to pressurize the fluid sufficiently to overcome the threshold of valve 126.

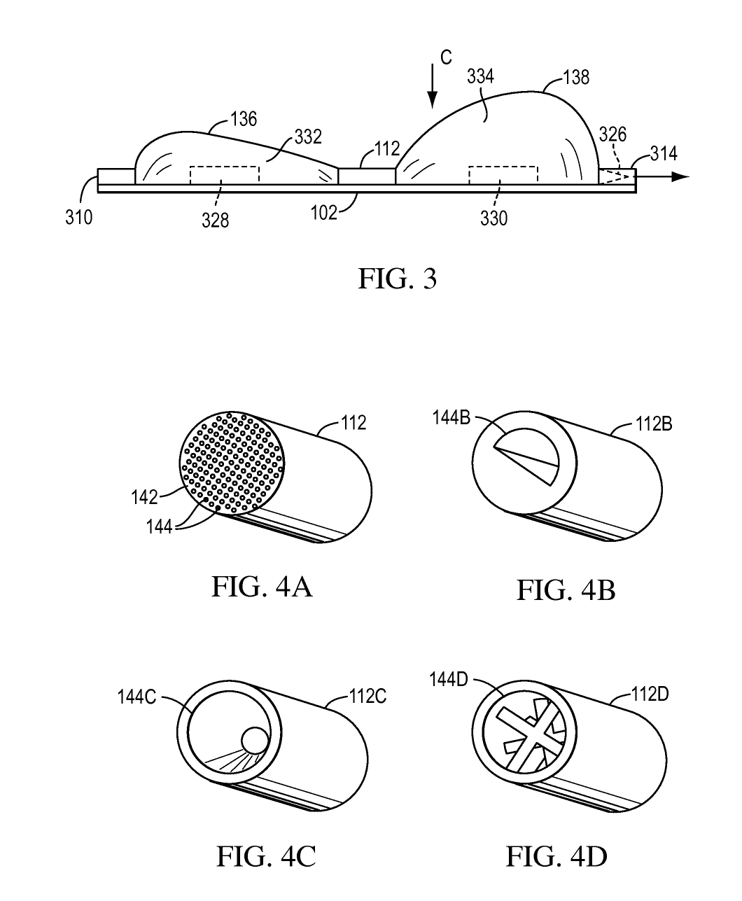

In lieu of simultaneous depression of both arrows B of fluidic bags 106 and 108 as shown in FIG. 2E, in some exemplary embodiments, only one fluidic bag may be depressed to overcome the threshold pressure of the one-way valve 126. The device may be configured having an asymmetrical shape before deflation such that the size and shape of one fluidic bag differs from the size and shape of another fluidic bag. As illustrated in the exemplary embodiment of FIG. 3, a fluidic bag 138 may be larger than a fluidic bag 136, thus providing the device with an asymmetrical shape. Thus, control of the fluid pressure and the ability to overcome the threshold pressure of one-way valve 326 within respective inlet and outlet ports 310 and 314 can be dependent upon the size and shapes of the fluidic bags. The amount of volume of fluid within chambers 332 and 334 and the shape of the fluidic bags may determine the fluid pressure within the device. In an exemplary embodiment of the device having an asymmetrical configuration, only the largest fluidic bag 138 may need to be depressed, for example, at a location indicated by the downwardly facing arrow C to increase the fluid pressure to overcome the pressure of one-way valve 326 within output port 314. Pressure restrictors 328 and 330 similar to those described with reference to FIGS. 2A-2E also may be used in the chambers 332 and 334.

In some embodiments, other mechanisms may be provided to remove the prepared sample from device 100, for example, such as by using suction or vacuum to draw the fluid out, with the vacuum being connected to the sample outlet port 114. Those skilled in the art would understand various modifications could be made in which the prepared sample could be removed through the outlet port.

The triturating element 112 can have a variety of configurations (e.g., size, shape, etc.) such that, for example, repeated flowing, of the biological sample through the triturating element 112 generates sufficient shear stress on the biological sample fluid, for example, to disrupt the cells in the biological sample. The triturating element 112 can be embedded within a microfluidic cartridge or microfluidic channel to perform the sample preparation. The triturating element 112 can include one or more through-holes of differing geometries and sizes, examples of which are discussed in more detail below, that create a shearing force on the sample to optimize the disruption of cells as the sample flows (e.g., back and forth) through the triturating element 112. The one or more through-holes can have geometric structures forming obstructions disposed within them so that the flow of the sample impinges these obstructions. The device attempts to create as much shearing force as possible as the sample moves through the through-holes of the triturating element 112.

In various exemplary embodiments, a sample preparation device can be cell specific such that the configuration of the triturating element (e.g., the configuration of the one or more through-holes) can be selected based upon the shearing rate required to accomplish disrupting of at least one cell of the biological sample that is selected for disrupting. Different bacteria or biological molecules selected for disrupting may have different shear rates or different disrupting efficiency, therefore needing different powers (e.g., amount of shear force) to accomplish cell disruption. Some bacteria (i.e., spores) may be harder to disrupt than others. Therefore, a sample preparation device can be configured having several differing interchangeable triturating elements with differing structures or geometries that can be inserted into and removed from the device to increase or decrease the shear for a different type of bacteria. The same device can be used to disrupt a variety of cells having different shear rates by selecting the appropriate geometric structure. However, in contrast, this may not necessarily be the case with chemical processes, because some chemical processes may struggle when processing spores or tougher cells. Thus, the chemical process may not be capable of expanding the entire range of cells. On the other hand, a sample preparation device in accordance with the present teachings may have the ability to use a variety of differing configurations so as to achieve an appropriate shear rate for a specific cell, and the device may be capable of expanding the entire range of cells.

As illustrated in FIG. 4A, in an exemplary embodiment, the triturating element 112 may have a solid body defining a closed lateral surface with opposite ends and at least one through-hole 144 formed within and extending between the ends. The triturating element 112 may thus be generally cylindrical-shaped and its lateral surface may define a substantially circular cross-section, as shown. Triturating elements in accordance with various exemplary embodiments of the present teachings may be cylindrical-shaped with cross-sections other than circular, such as, for example, square, rectangular, triangular, oval, etc; the shape of the cross-section of triturating element 112 is exemplary and nonlimiting.

The triturating element 112 may comprise a plurality of individual through-holes 144 formed therein to form a bundle designated by reference numeral 142. Through-holes 144 in the bundle 142 may be uniform, for example, having substantially the same size, shape, and other characteristic features. In lieu of a uniform configuration, at least some of the through-holes 144 may have size, shapes, and other configurations that differ from each other.

Each of the individual through-holes 144 may have a peripheral surface that defines a cylindrical shape having a substantially circular cross-section. Similar to the triturating element 112, the individual through-holes 144 may have peripheral surfaces defining a cylindrical shape with a cross-section other than circular, such as, for example, square, rectangular, triangular, oval, semi-circular, etc. At least some of the individual through-holes 144 also may have peripheral surfaces defining cross-sectional shapes that differ from each other and/or from the cross-sectional shape of the triturating element 112.

The through-holes 144 are configured to define at least one passage that extends substantially longitudinally along the triturating element 112 from a first end to a second end to allow sample to flow through the interior of the through-holes 144. FIGS. 4B, 4C, and 4D are exploded views depicting exemplary embodiments of various individual through-holes 144B, 144C, and 144D. FIG. 4B depicts an individual through-hole 144B defining at least one passage having a semi-circular cross-section shape. FIG. 4C illustrates an individual through-hole 144C defining at least one passage having an hour-glass shape. FIG. 4D depicts an individual through-hole 144D defining at least one passage having a circular cross-sectional shape and having at least one geometric structure in the form of a cross-haired shaped element disposed within the passage.

The body of the triturating element 112 may be substantially solid with one or more through-holes 144 formed therethrough. FIG. 4A illustrates a plurality of through-holes 144 formed within the triturating element 112. In various exemplary embodiments, however, the body of the triturating element 112 may define a single through-hole, as shown, for example, in FIGS. 4B-4D. In comparison to FIG. 4A, the exemplary embodiment of FIGS. 4B, 4C, and 4D each illustrate a single through-hole 144B, 144C, and 144D, respectively, instead of a plurality of through-holes. In various embodiments, a plurality of through-holes having any of the shapes depicted in the exemplary embodiments of FIGS. 4B-4D may be formed within the triturating element 112 to form bundles similar to bundle 142 of FIG. 4A

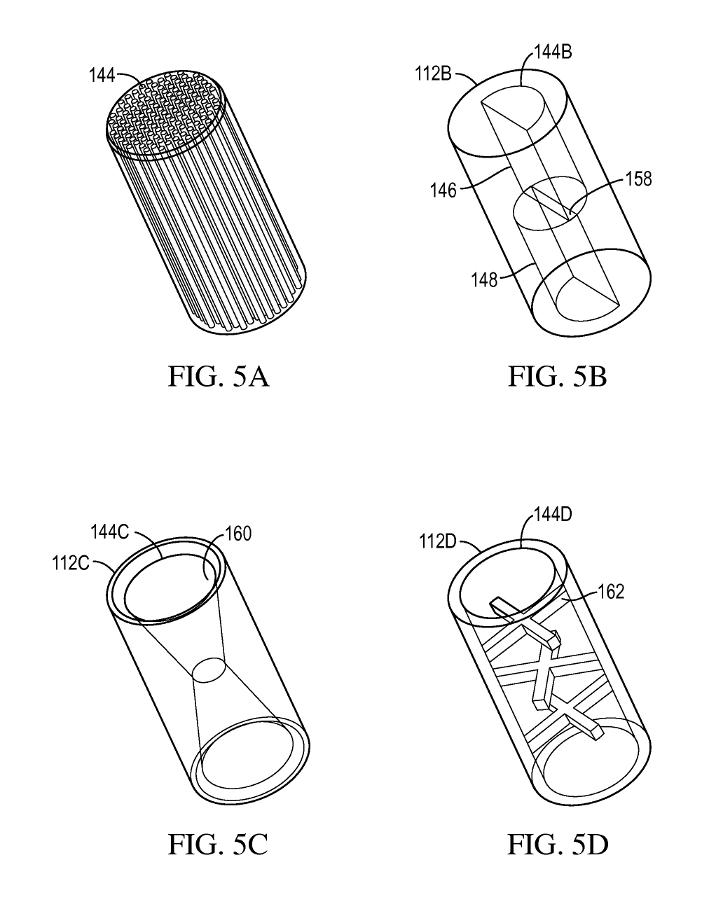

FIG. 5A illustrates the internal structure of the triturating element 112 of FIG. 4A, and FIGS. 5B-5D illustrate the internal structure of the embodiments of FIGS. 4B-4D, respectively.

In some embodiments, the solid body of the triturating element may include a plurality of through-holes, as shown in FIGS. 4A and 5A, which may be of a substantially uniform overall diameter and parallel to one another. As shown in FIGS. 4A and 5A, when using a plurality of the through-holes 144, the through-holes 144 can create a relatively large surface area over which the biological sample may travel as the biological sample passes through the triturating element 112. This may cause one or more cells present in the biological sample to be sheared against the surfaces (e.g., the interior surface), of the individual through-holes 144. The plurality of through-holes 144 may create a relatively high shear rate on the biological sample passing therethrough and can thus be employed for disrupting cells requiring a higher shear rate, such as cells having harder cell walls to disrupt.

FIG. 5B illustrates the internal structure of the triturating element 112B having a single through-hole 144B as shown in FIG. 4B. In FIG. 5B, the through-hole 144B may be defined by the union of two oppositely facing and offset semi-cylindrical passages. As shown in FIG. 5B, the passage formed by through-hole 144B may comprise two semi-circular shaped passages 146 and 148 that are disposed end-to-end and are offset laterally from each other. The passages 146 and 148 may face in substantially opposite directions such that their respective arcs are facing away from each other. The passage 146 may extend from one end of the through-hole 144B to approximately mid-length of the through-hole 144B, and the passage 148 may extend from approximately mid-length of the through-hole 144B to the other end of the through-hole 144B. The first passage 146 may have a semi-circular cross-section and the second passage 148 can be a mirror-image of the first passage 146. The first passage 146 and the second passage 148 can be configured to overlap laterally at a small narrow portion 158, as shown in FIG. 5B, and may be in flow communication with each other. The positioning of passages 146 and 148 may therefore create an abrupt change in the size (e.g., decrease) of the through-hole 144B defined by the passages 146 and 148. This abrupt change may generate an abrupt shear force on the biological sample traveling through the through-hole 144B. In various exemplary embodiments, this abrupt shear force may be similar to a step-wise function.

FIG. 5C illustrates the internal structure of triturating element 112 having a single through-hole as shown in FIG. 4C. The passage defined by the through-hole 144C may have a hour-glass shape 160. In FIG. 5C, through-hole 144C is of a uniformly decreasing diameter for the first half of the length of the triturating element 112 and then a uniformly increasing diameter through the second half of the triturating element 112. For example, the passage formed by the through-hole 144C may taper inwardly from two relatively wide openings disposed at opposite ends of the through-hole 144C to a relatively small opening disposed approximately mid-length of the through-hole 144C. The shear rate of the through-hole 144C in FIG. 5C may have a gradient so that initially the shear rate is lower; however, as the sample flows and bends toward the relatively small opening at the mid-length of the through-hole 144C, the shear rate increases. Then, as sample flows out of the through-hole 144C toward the relatively larger opening, the shear rate may again be lower.

FIG. 5D illustrates the internal structure of triturating element 112 having a single through-hole 144D as shown in FIG. 4D. In FIG. 5D, the through-hole 144D is a constant diameter cylinder obstructed with three cross-shaped geometric structures 162 disposed substantially perpendicular to and equally spaced along the longitudinal axis of triturating element 112. The second cross-shaped structure is rotated in all states operation about 30 degrees from the first, and the third cross-shaped structure is rotated about 30 degrees from the second cross-shaped structure. Thus, the cross-shaped structures may be oriented so as to be substantially out of alignment with each other. Alternatively, at least some of the cross-shaped structures 162 could be aligned with each other. The through-hole 144D may define a passage having a substantially uniform cross-section, such as, for example, a circular cross-section having a diameter that is relatively large compared to the overall diameter of the triturating element 112D, as shown. Due to the surface area, the crosses 162 may create a shear force on the sample traveling through the through-hole 144D. Depending on the size of the geometric structures, e.g., cross-shaped elements 162, and the surface area of the geometric structures onto which the sample must impinge as it travels through the through-hole 144D, the shear rate may vary. In the exemplary embodiment of FIG. 5D, wherein the surface area of the geometric structures 162 is relatively low compared to the cross-section area of the opening defined by the conduit, a relatively low shear rate may be achieved.

It should be understood that the cross-shaped elements 162 depicted in FIG. 5D are exemplary only and those having ordinary skill in the art would appreciate that a variety of geometric structures having differing configurations and numbers (e.g., other than 3) may be substituted for or used in conjunction with the cross-shaped elements 162. The plurality of geometric structures may include geometric structures of the same or differing configurations.

It should be understood that the individual through-holes 144B-144D shown and described with reference to FIGS. 4B-4D and 5B-5D are nonlimiting and exemplary only. Those skilled in the art would understand that various sizes, shapes, and configurations may be envisioned for the through-holes 144 without departing from the scope of the present teachings. Moreover, configurations and number of the through-holes 144 may be selected so as to achieve a desired shearing rate, as discussed above, for example, depending on the type of cells in a biological sample for which disrupting may be desired. Also, the combination of the through-holes 144 that form the bundle 142 of the triturating element 112 in FIGS. 4A and 5A may be selected so as to achieve desired sample preparation (e.g., disrupting). As described above, with reference, a triturating element 112 in accordance with exemplary embodiments of the present teachings may define any number of through-holes 144, including a single through-hole, to achieve sufficient shearing of a liquid being passed therethrough for cell disruption.

In some embodiments, when, for example, the intended sample to be used in the assay(s) is that collected on a Buccal swab or blood, a sample preparation area can be integral to a reaction zone.

In use, at least one of chambers 132 and 134 of the sample preparation device 100 can be prefilled with reagents, whether in liquid, dried down, or lyophilized form, for processing of a sample prior to real-time PCR. A biological sample may be collected using a suitable sample collection device, such as, for example, a swab. The sample collection device (not shown) may be inserted into device 100, through, for example, a luer-lock valve (not shown) in the inlet port 110. The sample may be released from the sample collection device into the sample preparation device 100. That is, the sample may be introduced via the inlet port 110 into chamber 132. The sample collection device may then be removed from device 100 by retraction back through the inlet port 110, and the device 100 may then be sealed by one-way valve 124. A sample preparation protocol may then be implemented, which, in some embodiments, may include alternately collapsing fluidic bags 106 and 108 to flow the sample fluid through the triturating element 112, for example repeatedly back and forth through the triturating element 112. The triturating element 112 may be configured such that flowing of the biological sample through the triturating element 112 may generate sufficient shear stress on the biological sample fluid to disrupt the cells. The number of times the biological sample flows through the element 112 to generate the sufficient shear stress may depend on various factors, such as, for example, the type of biological sample and cells therein for which it is desired to disrupt and release the desired nucleic acid.

After completion of the sample preparation protocol, the prepared biological sample may be removed from the sample preparation device 100 through outlet port 114. In various exemplary embodiments, removal of the prepared biological sample may occur via compression of either one or both fluidic bags 106 and 108 to overcome the threshold pressure of valve 126 to open valve 126. In various exemplary embodiments, the outlet port 114 may be in flow communication with a further device or zone of a device for performing desired processing (e.g., reactions) with the biological sample, including, for example, PCR, as shown in FIG. 6, for example.

For certain field or clinical applications, it may be advantageous to integrate analyte sample preparation, including nucleic acid extraction and/or purification directly into a consumable assay device. Such an embodiment 600 is illustrated in FIG. 6. FIG. 6 illustrates a sample preparation area for performing a preparation process on a biological sample prior to loading the processed sample into reaction zone 150 for the desired biological assay. A “separation area”, indicated along the dotted line labeled “separation area” may be included to isolate the sample preparation zone 154 from the reaction zone 150. Fluid containing the Buccal swab sample can be introduced into the inlet port 110 and a nucleic acid extraction step may be performed (e.g., lysis) as described in conjunction with FIGS. 1-5, for example, by alternating compression of the bags 106 and 108. After completion of the sample preparation, the nucleic acid sample can be transferred from the separation zone 154 into at least one fluidic channel 152 through a valve (e.g., a duckbill valve), for continued processing within the reaction zone 150. As described above with reference to the exemplary embodiments of FIGS. 2 and 3, the transfer of the sample from the sample preparation zone 154 to the reaction zone 150 may occur via various mechanisms, including, but not limited to, simultaneous compression of both fluidic bags 106 and 108, compression of a single fluidic bag if the bags 106 and 108 are asymmetric, and/or various other mechanisms configured to create a sufficient pressure differential to open the valve 126 and move the sample into the fluidic channel 152.

In general, reaction zone 150 may include any structure configured to define a reaction chamber to receive a biological sample for analysis and various flow control mechanisms to permit reagent and/or other substances from a source external to the flow cell into the reaction chamber to react with the biological sample contained in the reaction chamber. Those having skill in the art are familiar with various reaction chamber configurations.

FIG. 7 is a theoretical plot illustrating the disruption efficiency based on the relationship between the number of actuations and the disruption power. However, the relationship between the number of actuations and the disruption power may not necessarily be exactly linear. Instead, the disruption power may generally increase with the number of actuations. In addition to controlling the disruption efficiency based upon the configuration, number, and size of the individual elements contained within triturating element, sample preparation devices in accordance with the present teachings can also obtain greater efficiency and higher disruption power by increasing the number of times the sample travels (e.g., flows) through the triturating element. Increasing the number of actuations (e.g., times the sample flows through the triturating element) increases the shear rate, and, hence, disruption of tougher cells may be accomplished.

In various embodiments, device 100 may be employed as an atomizer and be used to deliver prepared sample to a mass spectrometry based device for analysis.

It will be apparent to those skilled in the art that various modifications and variations can be made to the sample preparation device and method of the present disclosure without departing from the scope its teachings. By way of example, sample preparation devices in accordance with the present teachings may include any number of chambers and/or fluidic bags, and such chambers may be connected via various channels and valving mechanisms, for example, in parallel and/or in series. In this way, sample may be introduced into a common inlet port and distributed to numerous chambers in association with numerous triturating elements to achieve simultaneous preparation of multiple sample volumes. In various other embodiments, a sample preparation device may permit the introduction of more than one type of biological sample and differing sample preparation protocols may be performed in chambers of differing portions of the device.

In some embodiments, the structures of triturating element 112 can be formed using a stereolithography process. In at least these embodiments, element 112 can be a monolithic piece with one or more through-holes.

In some embodiments, triturating element 112 can be formed using a photo-lithography process, where a planar substrate is covered with a photo-imagable material and imaged to develop the desired structures defining the one or more through holes in element 112. As depicted in FIG. 8, which is a top view of a pattern of rectangular structures 156 on planar substrate 102 through photolithography, wherein the pattern consists of rows of equally spaced rectangles, offset from one another such that in each row, a rectangle is centered in the space between the rectangles of an immediately adjacent row. Thus sample flowing through this pattern will have a tortuous path with many turns between chambers.

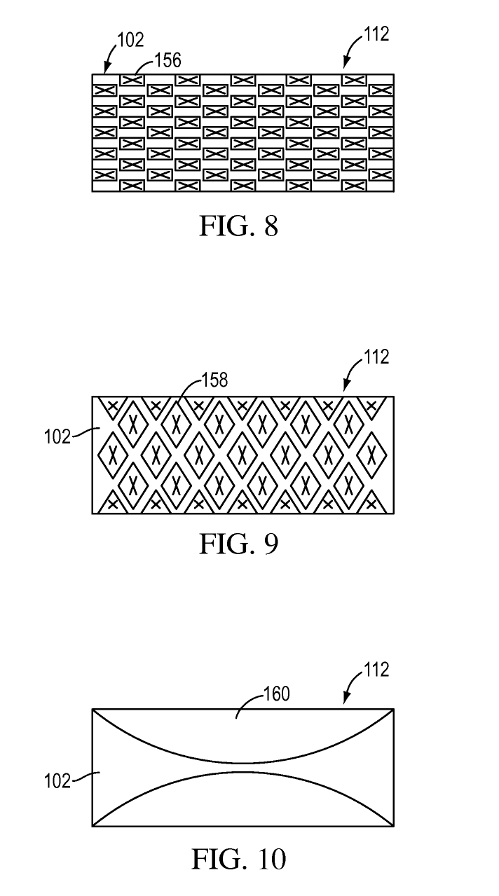

FIG. 9 depicts a top view of another pattern for a triturating element 112, which can be formed by photolithography. The pattern depicted in FIG. 9 consists of rows of parallelepipeds 158 arranged in a similar pattern to that depicted in FIG. 8, however, angled with respect to the longitudinal axis of element 112.

FIG. 10 depicts a top view of yet another exemplary pattern for a triturating element 112, which can be formed by photolithography. The pattern depicted in FIG. 10 consists of two semicircles 160 with the convex surface of their curved portions facing each other forming a single “venturi-like” passageway between them.

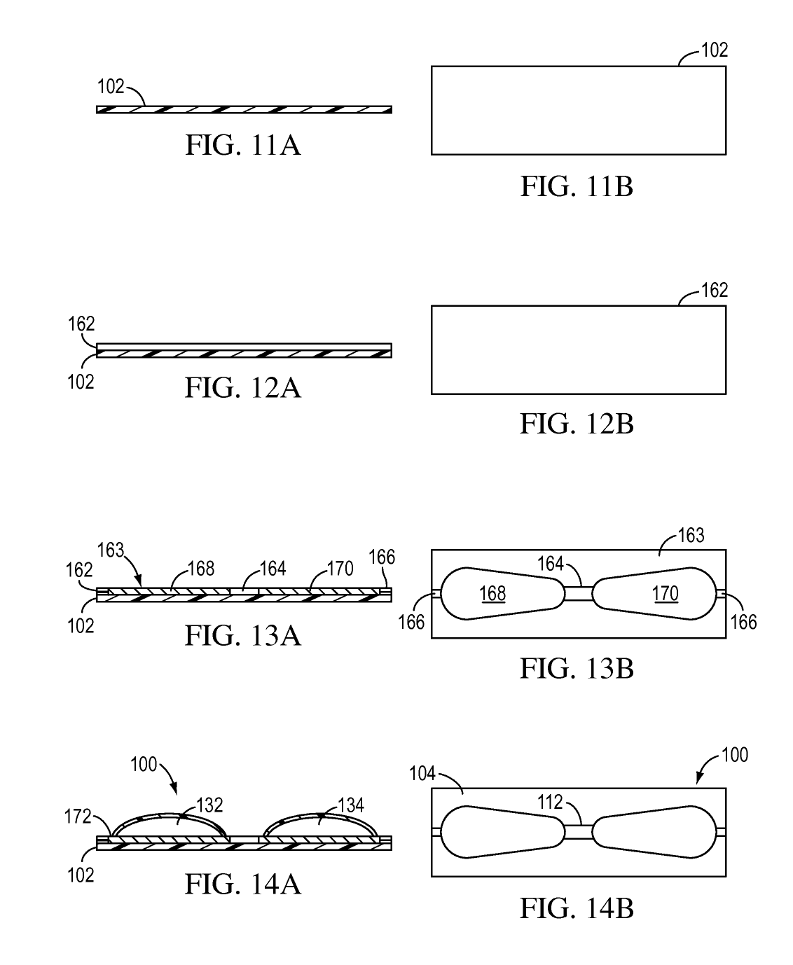

In various embodiments, element 112 and at least a portion of base plate 102 can be formed through photolithography. FIGS. 11A through 14B illustrate steps in a method of manufacturing an embodiment of a sample preparation device. FIGS. 11A and 11B depict the top and side view of a first step of providing a substrate 102. FIGS. 12A and 12B illustrate an applied layer of a photo-imagable layer 162 to substrate 102. After successive layers have been processed and the undeveloped portions etched away, the formed layers can appear as a photo-imaged layer 164 depicted in FIG. 13A and 13B, having a first recess 168, a patterned section 164, and a second recess 170. Patterned section 164 can have regular or irregular micrometer sized structures projecting from substrate 102. One-way valves 166 or a sample introduction port and a pressure-threshold release valve can be set into recesses 168 and 170 and attached to photo-imaged layer 163. In some embodiments, these fluidic control elements are sealed to photo-imaged layer 163. FIGS. 14A and 14B depict a molded plastic layer 172 attached to photo-imaged layer 163, creating two chambers 132 and 134 with a triturating element 112 disposed between and providing fluid communication between chambers 132 and 134.

Other embodiments of the disclosure will be apparent to those skilled in the art from consideration of the specification and practice of the teachings disclosed herein. It is intended that the specification and examples be considered as exemplary only.

1. A device for preparing a biological sample for analysis, the device comprising:
a first chamber configured to contain at least one biological sample;
a second chamber configured to contain at least one biological sample; and
a triturating element interdisposed between the first chamber and the second chamber and providing fluid communication between the first chamber and the second chamber.

2. The device of claim 1, wherein the first chamber, the second chamber, and the triturating element are at least partially defined by a common surface.

3. The device of claim 1, wherein the first and second chambers are collapsible and configured such that alternate collapsing of the first chamber and the second chamber flows the at least one biological sample through the triturating element to facilitate sample preparation.

4. The device of claim 1, further comprising an outlet port configured to flow a prepared biological sample into at least one reaction zone.

5. The device of claim 4, wherein the first and second chambers are collapsible and wherein collapsing of at least one of the first and second chambers transfers the prepared biological sample through the outlet port.

6. The device of claim 5, wherein the first and second chambers are configured such that simultaneous collapsing of the first and second chambers transfers the prepared biological sample through the outlet port.

7. The device of claim 1, wherein the triturating element is configured to disrupt at least one cell of the at least one biological sample.

8. The device of claim 1, wherein the triturating element defines at least one through-hole.

9. The device of claim 8, wherein the at least one through-hole has a circular cross- section.

10. The device of claim 8, further comprising at least one geometric structure disposed within the at least one through-hole.

11. (canceled)

12. (canceled)

13. (canceled)

14. (canceled)

15. The device of claim 8, wherein the triturating element defines a plurality of through-holes.

16. The device of claim 15, wherein at least some of the plurality of through-holes have differing configurations.

17. The device of claim 1, wherein a configuration of the triturating element is selected based upon a shearing rate.

18. The device of claim 17, wherein the shearing rate is selected based upon at least one cell of the at least one biological sample selected for disrupting.

19. The device of claim 1, wherein the first and second chambers comprise fluidic bags.

20. The device of claim 1, wherein at least one of the first and second chambers is configured to be preloaded with at least one material for facilitating sample preparation.

21. The device of claim 1, wherein at least one of the first and second chambers is collapsible.

22. The device of claim 1, wherein the triturating element is configured to disrupt at least some cells contained in the at least one biological sample.

23. The device of claim 1, wherein the device comprises a microfluidic device.

24. The device of claim 1, wherein the device is disposable.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38-40. (canceled)
